(19) United States
(12) Patent Application Publication
(10) Pub. No.: US 2010/0008072 A1
(43) Pub. Date: Jan. 14, 2010

(54) ELECTRICALLY POWERED MODULAR FURNITURE SYSTEM

(75) Inventors: Peter Meier-Graichen, Hamburg (DE); Oliver Boehme, Hamburg (DE)

Correspondence Address: Philips Intellectual Property and Standards, P.O. Box 3001, Briarcliff Manor, NY, 10510-8001, US

(73) Assignee: KONINKLIJKE PHILIPS ELECTRONICS N V, Eindhoven (NL)

(21) Appl. No.: 12/439,219

(22) PCT Filed: Aug. 31, 2007
(86) PCT No.: PCT/IB2007/053512

§ 371 Date: Sep. 1, 2009

(30) Foreign Application Priority Data
Sep. 5, 2006 (EP) 06120127.3

(51) Int. Cl. F21V 33/00; H02B 1/015

(52) U.S. Cl. 362/127; 174/500

(57) ABSTRACT

An electrically powered modular furniture system comprising a first furniture member equipped with a low voltage electrical fixture, secured to a main surface of said first furniture member, and with low voltage conduit means comprising a pair of co-operating apertured conductor rails secured in an interfacial arrangement to a main surface of said first furniture member, the conductor rails comprising portions of a detachable electrical connector assembly is distinguished by its great simplicity in manufacture, its low cost and its versatility of application. It permits realization of combination furniture, which in practical use can be remodeled any time without the use of tools and which is so simple to mount that the mounting can be carried out by unskilled persons.

### BACKGROUND OF THE INVENTION

The present invention relates to an electrically powered modular furniture system. More particularly, the present invention relates to an electrically powered modular furniture system that is comprised of a few basic components that can be assembled into multiple different configurations of furniture units.

As such, a modular furniture system enables a customer to buy component pieces and custom design to fit his needs.

Conventional modular furniture design for the mass market is generally limited to wood and plastic construction. Electrically powered components are generally not offered in conventional furniture systems, since most manufacturers are neither facilitated nor staffed for the installation of wiring, couplings, and electrical components.

Yet there is a need for such systems, particularly electrically powered and illuminated furniture systems, comprising lighting fixtures to illuminate an item on a shelf or a workspace.

Existing modular furniture systems incorporating lighting fixtures typically involve the use of wiring, which must be run internal within the system components or otherwise hang out in an unsightly and potentially dangerous fashion.

An integrally powered modular furniture, having vertical members with internal conductors is known From U.S. Pat. No. 6,527,406 B1. The conductors are coupled to a source of low voltage electrical power such that adjacent vertical members are of differing electrical polarity. Support members for use in the modular furniture system are designed to make electrical contact with the internal conductors when engaged in a vertical member. An electrical device, such as a light fixture, may be coupled between a pair of brackets engaged in vertical members of opposite polarity, energizing the electrical device.

However, these furniture systems have failed to offer many of the advantages found in the present invention.

What is required is a modular furniture system both mechanically and electrically integrated so as to facilitate the rapid and low-cost assembling of electrically powered furniture components in various configurations, thereby improving the affordability of electrically powered furniture for the mass market.

### SUMMARY OF THE INVENTION

These and other objects are achieved by an electrically powered modular furniture system comprising a first furniture member equipped with a low voltage electrical fixture, secured to a main surface of said first furniture member, and with low voltage conduit means comprising a pair of co-operating apertured (offenliegend!) conductor rails secured in an interfacial arrangement to a main surface of said first furniture member, the conductor rails comprising portions of a detachable electrical connector assembly.

The inventive modular furniture system is distinguished by its great simplicity in manufacture, its low cost and its versatility of application. It permits realization of combination furniture, which in practical use can be remodeled any time without the use of tools and which is so simple to mount that the mounting can be carried out by unskilled persons.

The apertured conductor rails according to the invention are especially suited for a modular system of detachable connector assemblies in multiple positions providing lateral, and/or perpendicular and or hinged electrical joining of furniture members The conductor rails typically do not protrude outside the main surfaces of the furniture components and the front face of the rails and the surface face of the panel in-between are substantially planar in order to provide planar surfaces, in which the electrical fixtures are located, and also planar rear surfaces for aesthetical reasons. In this manner the furniture system has an attractive appearance.

According to a preferred embodiment of the invention the electrical fixture is a lighting fixture.

According to one variant of the invention a connector assembly of the insertion type is used. Advantageously plug and receptacle connectors are used.

According to another variant of the invention a connector assembly of the form contact type is used.

The electrically powered modular furniture system may comprise a second furniture member equipped with a pair of co-operating apertured conductor rails secured in an interfacial arrangement to a main surface of said second furniture member, the conductor rails also comprising portions of a detachable electrical connector assembly.

The total furniture assembly with its light sources at specific positions, connection to power source, be it integral such as with on board batteries, or external from a power line constitutes a complete electrically powered modular furniture system comprising a modular conduit system.

A first and a second furniture member may be joined laterally, whereby the conductor rails are aligned pairwise and generally co-planar.

A first and a second furniture member may otherwise be joined perpendicular without interrupting the modular conduit system.

According to a very preferred embodiment of the invention a modular furniture system is provided, wherein the connector assembly is formed as to provide mechanical fastener means.

The furniture units, which can be composed in this manner, present perfect positioning and absolutely ensure stability even without fixation based on mechanical fasteners.

This embodiment of an electrically powered modular furniture system provides a high degree of solidity to the whole piece of furniture, yet does not cost too much.

It can be assembled, mounted, and/or dismantled without the use of special tools, i.e., in such a manner that any user without special skills can perform these operations.

### DETAILED DESCRIPTION OF THE INVENTION

The present invention is directed to an electrically powered modular furniture system that is easily assembled and disassembled and that can be set up in a variety of different arrangements. The system provides furniture units, such as racks, cabinets, drawers, and lighting strips panels comprising one or two major families, or types, of furniture members.

The first family of furniture members are panels, shelves, borders, hinged doors etc. bearing an integrated electrical fixture, preferably a lighting fixture, and modular electrical conduit means.

The second family of furniture members are supporting and/or joining components such as panels, shelves, sidewalls, frames, borders, which serve to support a first furniture member or to join it to a power supply, comprising modular circuit means, but no electrical fixture.

Here and in the following the terms “top”, bottom”, “rear”, “side”, “front” and “down” are used only to facilitate description of the claimed invention and do not limit the orientation of a furniture member in a furniture unit.

The various members can be in different sizes, and can be configured together in various combinations and sub-combinations to form a furniture unit having a desired configuration according to user requirements and/or the environment within which the storage unit is to be used.

### BRIEF DESCRIPTION OF THE DRAWINGS

In the drawings,

FIG. 1 is a perspective view of first embodiments of an electrically powered furniture member, which is constructed, with the modular features of the present invention.

FIG. 2 is a perspective view of a connector assembly between a first and a second furniture member.

FIG. 3 is a perspective view of a first embodiment of a lighting strip unit according to the invention

FIG. 4 is a perspective view of a second embodiment of a lighting strip unit according to the invention

FIG. 5 is a perspective view of a first embodiment of an illuminated rack unit according to the invention comprising first and second lighting fixtures.

FIG. 6 is a perspective view of second embodiment of an illuminated rack unit according to the invention.

FIG. 7 is a perspective view of a connector assembly comprising a semi-tubular receptacle.

FIG. 8 shows to embodiments of an electrically powered and illuminated furniture unit comprising a hinged door.

FIG. 9 is a perspective view of a cantilever shelf unit according to the invention.

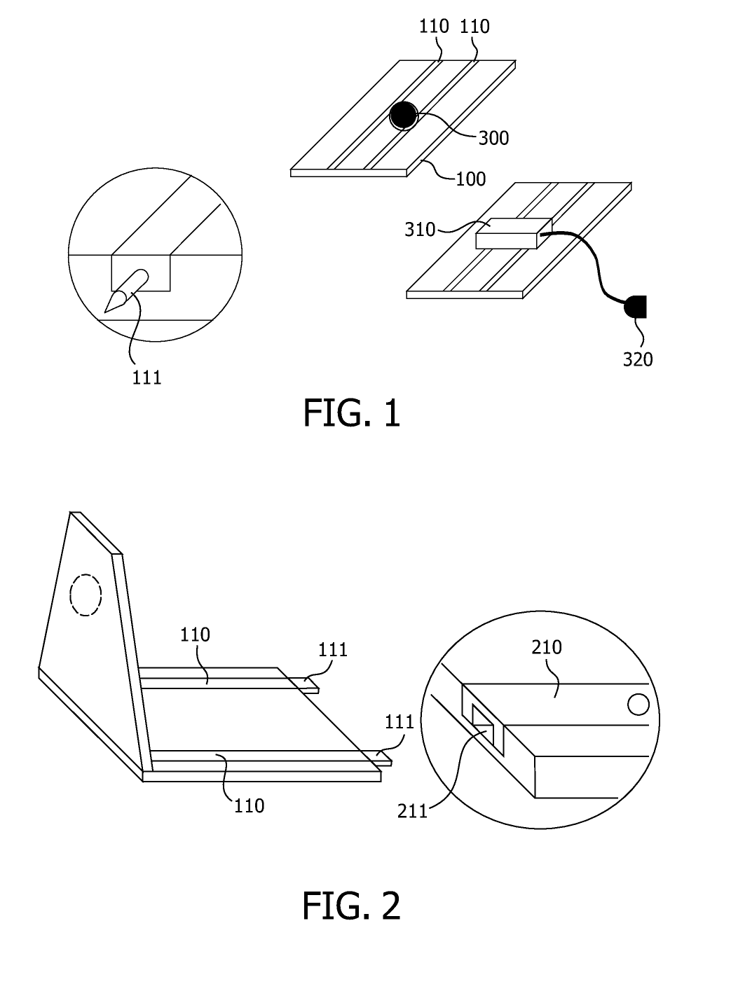

Referring to FIG. 1, it can be seen that first furniture members 100 are typically planar structures each including opposed first and second main surfaces, side faces perpendicular to the first and second main surfaces and coupled thereto such that lateral edges of the side faces are coupled to lateral edges of the first and second main surfaces.

The first furniture members are preferably of the rectangular shape shown, of a height “H” and a width “W”, though other shapes may be used, which have flat surfaces, such as triangles, octagons, and the like which allow attachment of an integrated electrical fixtures The furniture members also need not to be flat, e.g. they may have a curvature as well.

Furniture members are typically formed of common furniture construction materials including natural materials, such as various woods, marble or stone, manmade products, such as MDF, Fin ply (™), Corian(™) or glass can also be used. Furthermore, composite materials, such as reinforced Formica(™) can be used as well. Preferably furniture components used in this invention are made from insulating material such as woods or a plastic material.

The first furniture member includes a low voltage electrical fixture 300 being connected to a first main surface of the component.

The electrical fixtures may take a variety of forms to provide various types and quantities of lighting, switch designs and utilities and other applications.

According to a preferred embodiment of the invention a modular furniture system comprises at least one low voltage lighting fixture, such as a fixture for a low voltage incandescent, fluorescent or LED lamp.

Discrete or strip lighting fixtures may be used. There may be similar lighting fixtures provided at all the first furniture members, or there may be differences in the lighting of at least some of the members so that the user has a selection of lighting options to choose from to suit his requirements and for different lighting effects.

The integrated electrical fixtures incorporate also ancillary electric circuits means for power, detection and control that constitute a complete modular low-voltage conduit design.

Ancillary circuit means may include power control elements such as an electrical mains voltage adapter 310. Preferably the adapter is a compact unit, which will not be unduly conspicuous or may be concealed from view in the system. Power controller 310 includes an AC/DC converter fabricated in accordance with conventional fabrication techniques, which may further include an external power input 320.

Also one or more switches may be provided. Such switches may be, but are not limited to, timer settings, multiple switch settings for multiple light, and remote control activation.

To power an electrical fixture the two terminals of the electrical fixture must be electrically connected directly or indirectly to opposite poles of a source of electrical power.

Therefore the first furniture member 100 includes a pair of co-operating apertured spaced-apart first and second conductor rails 110 being integrated into a main surface of the member.

The apertured conductor rails 110 may be formed from conductive metals, such as steel, aluminium, brass or the like.

Advantageously, rails 110 are solid in construction, preferably having a square or rectangular cross section. According to another embodiment the conductor rails are trapezoidal in cross section or rectangular with lateral guide bars. Undercut wedge-shaped cross sections, e.g. similar to a dovetail, could also be provided.

Typically the front face of the rails is sleek, but according to an alternative embodiment of the invention the front face of the rails may comprise decorative elements, such as ornaments, or a convex or concave, curved or angular surface.

To provide an interfacial arrangement of the apertured conductor rails and in order to firmly secure said rails, they are slot-fitted into a main surface of the first furniture member.

A pair of open slots encompasses the pair of apertured conductor rails in a form- or force-locking way and substantially flush with the main surface of the furniture member.

According to a preferred embodiment the furniture member is formed with a pair of rails that extend from a side face into a main surface unto the attachment point of an electrical fixture 300.

According to alternative embodiment the furniture component is formed with a pair of rails that extend through the main surface from a side face unto the opposite side face.

Maximum depth of the apertured conductor rails is advantageously smaller than or equal to half the height of the cross section of the first furniture component.

The front face of the rails and the surface of the furniture member in-between are typically substantially planar in order to provide planar surfaces in which the electrical fixtures are located.

The pair of rails is placed away from the fringe of the main surface with a gap narrower than the edges of the main surface.

According to one embodiment of the invention co-operating pairs of rails 110 are arranged so as to be physically separated by a uniform gap rails that matches the gap between the terminals of the electrical fixture, so that one portion of each rail contacts the electrical fixture.

According to an alternative embodiment of the invention a co-operating pairs of rails 110 are angled and arranged so as to be physically separated by a non-uniform gap to meet either side of an electrical fixture so that one portion of each rail contacts the electrical fixture.

Apertured conductor rails 110 are fastened to the terminals of the electrical fixtures via techniques understood in the art.

To provide a modular conduit system and to power an electrical fixture attached to a furniture member the apertured conductor rails must also be electrically connected directly or indirectly to opposite poles of a power supply.

According to a preferred embodiment of the invention the first furniture member 100 is connected to a power supply via at least one second furniture member 200.

Second furniture members 200 may be members such as supporting members sidewalls, extensions.

Second furniture members 200 are also provided with a co-operating spaced-apart pair of apertured conductor rails 210, similar in design to rails 110.

For joining first and second members the furniture component is adapted with one or more cooperative detachable joining means for electrically interconnecting, and mechanically inter-fastening a plurality of furniture members to allow for a modular furniture system comprising a modular electric conduit system.

For joining a first and a second furniture member mechanical interfastening means 400 are needed.

In principle, the first furniture member can be mechanical fastened to the second furniture member in desired positions in any conventional manner.

For example, they can be permanently attached to each other by welds, brazing, adhesive or cohesive bonding material.

However, detachable interfastening means by bolts, screws, hooks, rivets, pins, posts, clips, clamps, buckles, and other conventional fasteners are a preferred modification in order to provide a simple and inexpensive modular design.

Electrical interconnection is made via connector assemblies attached to portions of the conductor rails. Parts of connector assemblies are provided to the rails for releasable connecting them pairwise to pairs of rails to an adjacent furniture member or to a power supply for a modular electrical conduit. According to one embodiment of the invention the connector assembly may penetrate through the height of a furniture member.

According to a preferred embodiment of the invention portions of the conductor rails are provide with detachable electrical connectors parts.

The apertured conductor rails according to the invention are especially suited for a modular system of detachable connector assemblies in multiple positions providing lateral, and/or perpendicular and or hinged electrical joining of furniture members.

Advantageously the detachable connector assemblies are of the insertion or pressure type.

A detachable connector assembly of the insertion type comprises a plug connector part and a matching receptacle connector part.

A detachable connector assembly of the form or pressure type comprises two matching contact face parts. The conductive portions of the two parts are brought together “head on”, i.e. they are disposed on the “front” ends of said parts in the direction in which they are brought together.

To permit a high degree of adjustability of the modular furniture system advantageously all conductor rails are provided with connector parts, although only two connector parts per member are needed.

Accordingly each conductor rail has at least one connector part disposed on its surface or otherwise on a lateral side face and adapted to be brought into contact with the contact part of a second furniture member or a power supply.

The connector assembly may have interconnecting detent means for providing locked engagement of the connector parts.

In a first variant of the present invention, a first furniture member is removable attached to a second member by an insertion connector assembly comprising a plug and a receptacle part.

Plugs and receptacles are designed to co-operate and mate with plugs and receptacles of adjacent furniture members.

In a first embodiment of this variant a first furniture component is removably attached to a second component in a position being laterally displaced with respect to another.

This embodiment of the invention is advantageous in cases, where several panels or shelves are connected so that they form a row.

To provide connection means for this kind of arrangements the end portions of the conductor rails are adapted as electrical plug 111 to be plugged in to the receptacles 211 at the end portions of conductor rails of another furniture component or a power supply.

As best shown in FIG. 2 the plugs 111 of a rail of a first furniture member extend into engagement with receptacles 211 on the side face of a conductor rail of a second furniture member.

A flat-pronged plug connector assembly shown in FIG. 2 is advantageously used where two panels are joined together in a common lateral plane.

Profiles of other shapes can also be used. In FIG. 1 a different type of plug-in connector assembly is shown, which has two rounded prongs, and has, quite logically, round holes for a receptacle.

The plug may also be provided spring-loaded members. The springs provide additional contact pressure for the connections, in case this is needed.

According to another embodiment of the invention shown in FIG. 7 the modular system uses loose insert cylindrical pins 112 that co-operate with tubular receptacles 114 of the first members and extend into corresponding cylindrical receptacles 212 in the rails of the second members.

The plugs and receptacles preferably extend to less than the width of the rails to ensure that the furniture members are flush with each other.

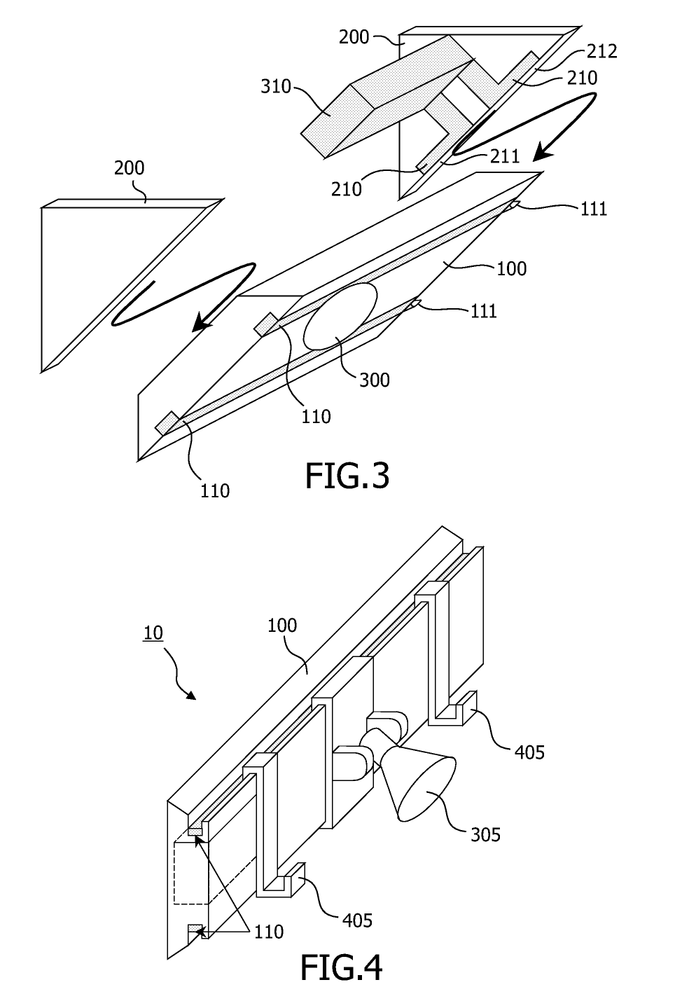

In FIGS. 3 and 4, a simple arrangement of modular furniture version of a modular furniture system according to the invention is shown.

FIG. 3 shows a perspective view of a lighting strip and the attachment thereof by a plug connector assembly comprising spring loaded tubular pins.

At least three furniture members, a base member 100 and two sidewall members 200 are assembled to form a strip lighting system that can be individually illuminated with one or more lighting fixtures 300.

The strip lighting system shown in FIG. 3 is used advantageously to project light down from the underside of a shelf or a cabinet. Therefore the upper and lower sidewalls of the first panel member are chamfered for a tilted arrangement of the strip lighting member under a shelf or a ceiling.

Several base members 100 can be joined for an aligned panel run.

The front surface of the base member 100 bears two spaced-apart conductor rails 110 to which a recessed lighting fixture 300, such as a small incandescent lamp, is connected. The terminals of the lamp are connected to a contact portion of the conducting rails in a suitable way.

The end portions of the conductor rails comprise plugs shaped as spring-mounted tubular pins 111, while the rails in the sidewall members comprise circular receptacles 212.

Positioned on side of first member 100 are a joining pair of vertical framing second furniture members 200 formed as a triangle, for hiding the cavity behind the tilted strip panel and also a mains voltage adapter 310.

The vertical panels bear angled conductor rails to meet the connector portions points of the tilted member. The end portions are provided with tubular receptacles.

FIG. 4 shows a perspective view of an alternate embodiment of a lighting strip 10. The primary difference between lighting strip shown in FIG. 4 and the lighting strip described above is the provision of an upwardly-opening groove therein. The groove extends along the entire length of base member and forms a continuous groove, which extends longitudinally along essentially the entire length of an aligned panel run. This arrangement permits continuous, uninterrupted sliding or adjustment of a detachable fixtures like fixture for a lamp 305 and item holders 405 along the entire length of the aligned panels.

In all other respects, lighting strip shown in FIG. 4 is substantially identical in structure and operation to lighting strips described above.

It should be understood that the plugs of a first furniture member need not necessarily engage laterally with receptacles on a side-face of a rail of a second furniture member.

There are all kinds of modular furniture arrangements wherein a plurality of furniture members are not linearly aligned but rather form an angle, either fixed or hinged, relative to each other.

According to a variant of the invention separate furniture members can be interconnected at 90-degree increment.

According to a preferred embodiment of the invention top surface portions of the conductor rails are provide with detachable electrical connectors assembly portions.

To provide connection means for this kind of arrangements the plug of a rail of a first furniture member extends into engagement with a receptacle on the top surface of a conductor apertured rail of a second furniture member.

This variant of the invention can be utilized advantageously to produce various types of furniture units including racks, bookshelves and/or shelves or cabinets, open or provided with doors.

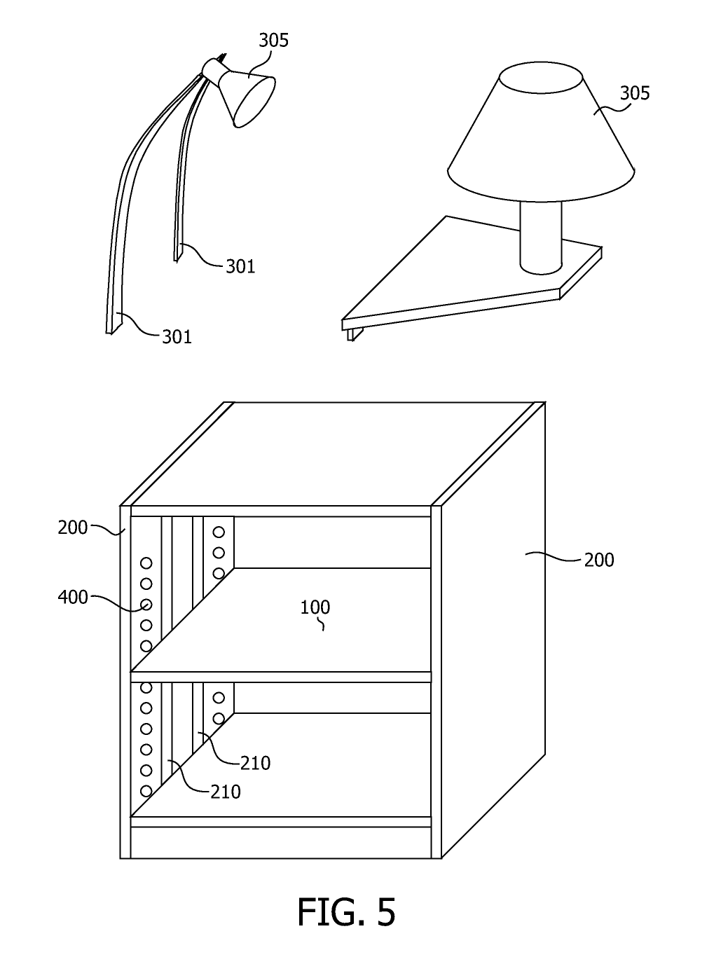

In FIG. 5 an example is shown of such type of the present invention, a shelving system with a shelf that can be individually illuminated with one or more lighting fixtures.

As shown in FIG. 5 a shelving system is formed from a pair of spaced apart depending sidewalls 200, a top wall and a bottom wall, which are joined to one another to form a support structure or frame.

The frame in turn supports at least one panel 100 independently and detachably mounted to the sidewalls of the underlying supporting structure at any angle relative to the support structure, preferably, horizontally thereto.

The mechanical joining of the frame members to each other and to the shelves is provided by conventional fastening means 400.

At least some of the shelves 100, potentially all of them (with the possible exception of the shelves at the base of the structure) have an electrical fixture mounted to a main surface.

The lighting fixture is normally positioned downwardly below and partially or completely recessed within the lower surface of a shelf panel.

So the light fixture is concealed and illuminates the underside of the shelf 100, whereby articles placed on a shelf below are suitably illuminated by concealed lighting

An alternative is a floodlight mounted to the topside to illuminate a ceiling.

The terminals 301 of the lamp 305 shown in FIG. 5 are connected to a pair of conducting rails (not shown), which extends along a main surface located at the same side of the shelf.

Alternatively, lamp 305 may form an electrical contact with a pair of conductor rails located at the other main surface of the shelf.

As best shown in FIGS. 4-5 of the drawings, each side panel 200 is provided with laterally and longitudinally spaced pairs of pair of conductor apertured rails. These rails having a plurality of spaced-apart receptacles formed in their top surface for receiving plugs integral with end portions of each conductor rail of panel 100 of one or more horizontal first furniture members.

So the rails of panel 100 and 200 will form a continuous electrical track from lighting fixture 300 to a power supply (not shown).

The conductor rails 210 of the sidewalls 200 extend along the whole length of the shelf sidewall toward the side face of the sidewall panel 200.

The free upper and lower ends of the apertured conductor rails 210 are preferably provided also with a receptacle thereon so as to enable the shell sidewall to be connected to a second kind of electrical lighting fixture or to a floor power supply.

In FIG. 5 a furniture unit comprising a second kind lighting fixtures, useful as a nightstand, is shown.

As can be best seen in FIG. 5 a lamp lower portion comprises means to be interconnected and fastened, to said side faces of co-operating pair of conductor rails in a sidewall member.

The means for such interconnections are comprised, for example, by a lamp two-part base comprising plugs for engagement to an interconnecting receptacle for securing the lamp to said sidewall.

The present invention lamp base may come in various models as shown in FIG. 5 and is particularly useful for emergency lighting.

It is obvious that the combination of electrical connectors and mechanical fasteners in the embodiment of FIG. 5 must be positioned with greatest precision. This can prove especially difficult when the size of the panels is taken into account. Such a design is also vulnerable to variations in the positions and dimensions of the pins and bores which can vary as a result of air condition changes (e.g., humidity, temperature).

So according to an especially preferred aspect of the invention the joint between two furniture members is such that portions of the conductor rails simultaneously serve as electrical connectors and mechanical fasteners.

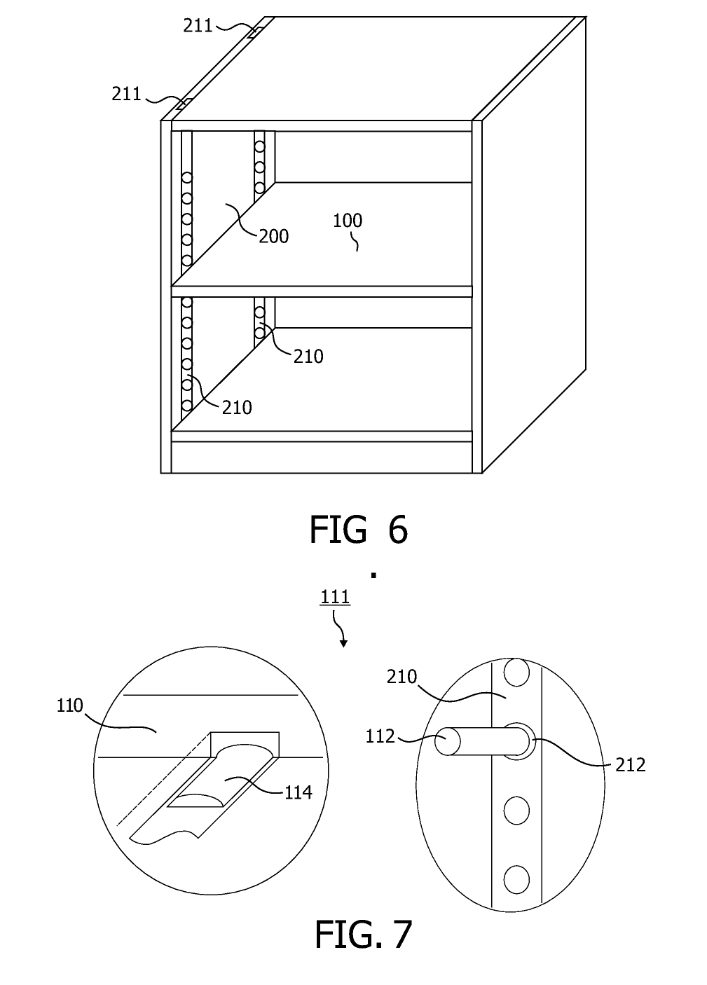

Referring to FIG. 6, the modular rack is again comprised of a pair of separately disposed and parallel vertical support members 200, fastened to a pair of likewise separately disposed and parallel horizontal top and bottom members.

A lighting fixture and a pair of separately disposed and parallel horizontal conductor rails are secured to the lower surface of the horizontal furniture member 100.

As compared with the embodiment of FIGS. 5, the apertured rails of the sidewall panels bearing vertical rows or columns of receptacles, are more widely spaced, i.e., a spacing in the order of ½ to ⅘ of the shelf width, preferably about ⅔ of the shelf width.

Because such columns of receptacles are more widely spaced in the embodiment of FIG. 6, the mechanical fastening between the sidewall 200 of the track and the panel 100 is sufficiently to provide resistance to the gravitational force occurring at the shelf-load supporting electrical connector assemblies.

So no mechanical fasteners are needed to physically join the illuminated panels to the sidewall panels. This helps to reduce manufacturing costs and provides more flexibility in the positioning of shelves.

In a preferred embodiment of the present invention, a first furniture unit can be removably attached to a second member in a plurality of positions, one of the positions being perpendicularly displaced with respect to another.

Yet another embodiment of the present invention is shown in FIG. 7, which basically corresponds to the one shown in FIGS. 5 and 6.

According to this embodiment, the receptacles 114 are of a semi-tubular form.

Each receptacle 114 comprises a semi-tubular cross-section defining a longitudinally extending shoulder.

The end of the pin 112 fits against the shoulder and prevents the connector assembly to disintegrate.

This positively locks the panel to the sidewalls. The advantage of the solution according to FIGS. 7 is seen in that this lock can be easily manually released, by withdrawing the panel from the pin support.

In a second variant of the present invention, a first furniture member is removably attached to a second member by pressure or form connector assembly.

The concept “based on form contact” signifies that two parts or elements are mutually joined only owing to their geometric form, and thus without the influence of any outer force (nuts and bolts or similar devices) to keep them together.

In order to join two rails by a connector assembly based on form contact at one ore more points, there is provided, in one of the surfaces of the rails at least one flat contact plate to co-operate with a flat counter contact plate.

Contact plate and counter contact plate have approximately square-shaped cross-sectional opening which essentially corresponds to the cross-section of the rails, if provided for lateral joining of two rails.

Such kind of pressure connector assemblies are especially useful where in an arrangement of modular furniture a plurality of furniture members form a variable angle relative to each other and the mechanical fasteners are hinge-joint fastener. Typical examples are doors, lids and louvers.

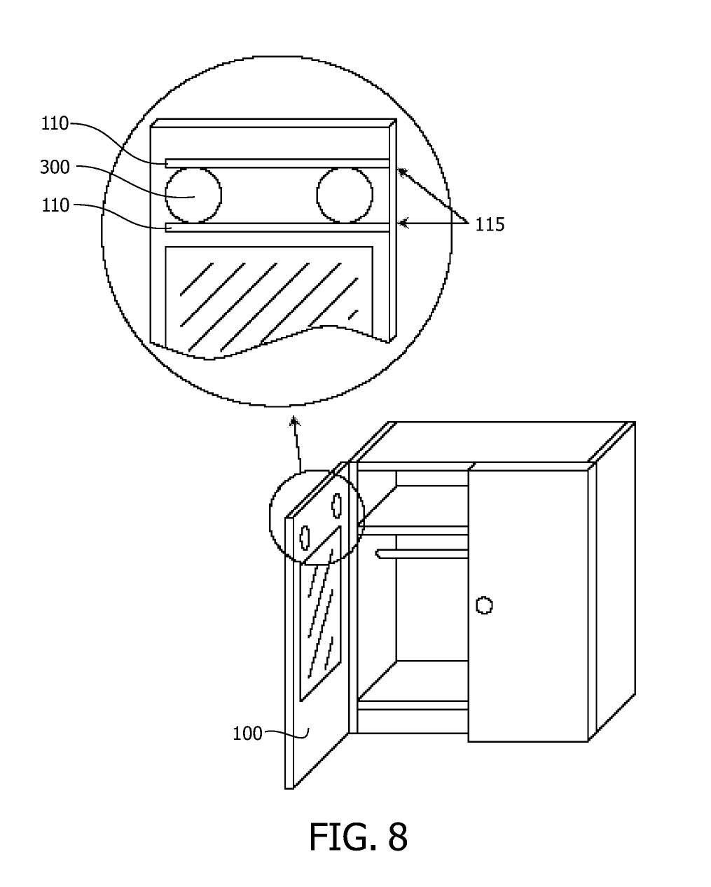

In FIG. 8 one inventive arrangement is shown in which the conjunction is based on pressure contact between two elements.

In the illustrated embodiment of FIG. 8, the front of wardrobe is closed by a door forming a 1^{st} furniture member 100, which is hingedly mounted at its upper edge to the end panels or top wall so as to be swingable upwardly into an open position.

A lighting fixture 300 is mounted to the inside surface of the door to illuminate a mirror and the content of the wardrobe.

The terminals of the lighting fixtures are connected to a pair of co-operating conductor rails 110 that extend to the lateral side face of the door that bears the hinge.

The side faces of these rails bear pressure connectors plates 115 that cooperate with complementary pressure connectors plated mounted on the leading ledge of the sidewall of the wardrobe.

On opening the door pressure contact is achieved between side faces of rails and side faces of the rails of the hinged door.

In still another arrangement of a modular furniture a plurality of furniture members are aligned in an angle relative to each other so as to form a cantilever arrangement.

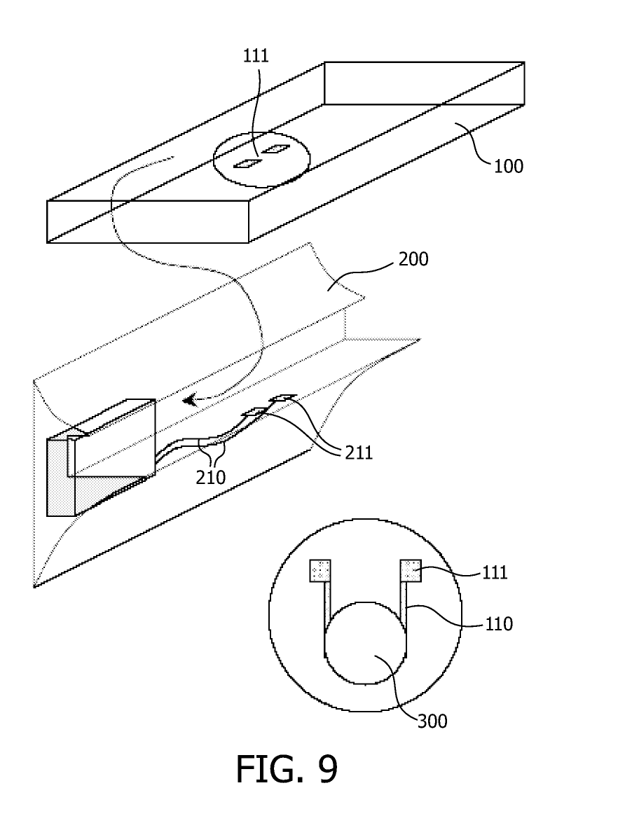

As can be best seen in FIG. 9 the cantilever shelf arrangement comprises as 2^{nd} furniture member a rearwall member 200 and as 1^{st} furniture member a shelf panel member 100.

An upper panel-catch and a lower panel-catch project outwardly from the outer surface of the rearwall member 200 to keep the shelf panel 100 in a horizontal position.

Cantilever shelf panel 100 comprises a downlight as lighting fixture and a pair of conductor rails running from opposite terminal positions of the downlight to end portions being shaped as form contacts plates.

The lower panel catch comprises a co-operating pair of conductor rails 210 extending from opposite end of the rearwall member to end portions 211, leaving a gap between them.

The end portions are shaped as form contact plates.

In order to join the two pair of rails via form contact at one ore more points, there is provided, in each of the surfaces of the rails 110 and 210 (i.e., the surfaces which contact each other) at least one contact plate.

The shelf is inserted in the rearwall catch by tilting it upwardly to a sufficient degree so that the shelf can pass between the catches Thereafter the shelf is pivoted downwardly until it assumes the seated position for its connector assembly parts.

This arrangement completes an electrical circuit and the lamp can be lit. The various types of furniture units, illustrated in the drawings, are preferred examples, although various other types of fastening units may also be employed, if desired.

### REFERENCE NUMERALS

100 Base member comprising electrical fixture

110 Rails connected to electrical fixtures

111/112 connector portions

200 Support unit

210 interconnecting Rails

211/222 connector portions

300 Electrical fixture

310 second electrical fixture

301 electrical fixture terminals

320 adapter

321 Power cord

400 fastener

1. An electrically powered modular furniture system, comprising:
a first furniture member having a main surface,
a second furniture member having a main surface,
a low voltage electrical fixture, secured to said main surface of said first furniture member, and
a low voltage conduit means comprising
a first pair of co-operating apertured conductor rails detachably secured to the main surface of said first furniture member, and
a second pair of co-operating apertured conductor rails detachably secured to the main surface of said second furniture member, the second pair of conductor rails are releasably connectable pairwise to the first pair of conductor rails, thereby forming a detachable electrical connector assembly.

2. A modular furniture system according to claim 1, wherein the electrical fixture is a lighting fixture.

3-5. (canceled)

6. A modular furniture system according to claim 1, wherein first and second furniture members are joinable laterally

7. A modular furniture system according to claim 1, wherein first and second furniture members are joinable perpendicular relative to each other.

8. A modular furniture system according to claim 1, wherein the electrical connector assembly comprises means for mechanically fastening first and second furniture members.
